(19) United States
(12) Patent Application Publication
(10) Pub. No.: US 2015/0316823 A1
(43) Pub. Date: Nov. 5, 2015

(54) PIXEL STRUCTURE

(71) Applicant: Shenzhen China Star Optoelectronics Technology Co., Ltd, Shenzhen, Guangdong (CN)

(72) Inventor: Sikun HAO, Shenzhen, Guangdong (CN)

(73) Assignee: Shenzhen China Star Optoelectronics Technology Co., Ltd., Shenzeng, Guangdong (CN)

(21) Appl. No.: 14/235,718

(22) PCT Filed: Nov. 28, 2013
(86) PCT No.: PCT/CN2013/088082

§ 371 Date: Jan. 28, 2014

(30) Foreign Application Priority Data
Nov. 25, 2013 (CN) 201310603199.2

(51) Int. Cl. G02F 1/1343; G02F 1/1339; G02F 1/1362

(52) U.S. Cl. CPC G02F 1/134363; G02F 1/13439; G02F 1/136286; G02F 1/136213; G02F 1/13394; G02F 2001/134372; G02F 2001/134318

(57) ABSTRACT

The present invention provides a pixel structure, which includes: a substrate (12), a lower common electrode (14), a gate line (26), a first passivation layer (16), a data line (28), a pixel electrode (18), a second passivation layer (22), and an upper common electrode (24). The first passivation layer (16) includes a first via hole. The second passivation layer (22) includes a second via hole. The lower common electrode (14) is connected through the first and second via holes to the upper common electrode (24). The lower common electrode (14) and the pixel electrode (18) partially overlap each other to form a first capacitor. The upper common electrode (24) and the pixel electrode (18) partially overlap each other to form a second capacitor. The first and second capacitors constitute a storage capacitor of the pixel structure.

### BACKGROUND OF THE INVENTION

1. Field of the Invention

The present invention relates to the field of displaying technology, and in particular to a pixel structure of a fringe field switching (FFS) mode liquid crystal display.

2. The Related Arts

The displaying technology has undergone rapid progress recently. A flat display device applies totally different techniques of displaying and manufacturing, making it significantly differing from the conventional video image displaying devices. The conventional video image displaying device is generally based on a cathode ray tube (CRT), from which a flat display device is made different primarily concerning changes made in respect of weight and size (thickness). Generally, a flat display device has a thickness not greater than 10 centimeters, among the other differences associated with various technical aspects, such as theory of displaying, manufacturing material, manufacturing process, driving for displaying video images.

A liquid crystal display (LCD) is one of the flat display devices that are most commonly used and comprise a color screen of high PPI (pixels per inch) and is widely used in various electronic equipment, such as a mobile phone, a personal digital assistant (PDA), a digital camera, a computer monitor, and a notebook computer screen.

A currently available liquid crystal display is generally composed of upper and lower substrates and a central liquid crystal layer and the substrates are each composed of a piece of glass and electrodes. If the upper and lower substrates are both provided with electrodes, then a liquid crystal display of a longitudinal electrical field mode can be provided, such as a TN (Twist Nematic) LCD, a VA (Vertical Alignment) LCD, and MVA (Multi-domain Vertical Alignment) LCD that is developed for addressing the issue of narrow viewing angle. Another category is different from the above-described LCDs and has only one of the substrates that is provided with electrodes so as to form an LCD of a lateral electrical field mode, such as an IPS (In-Plane Switching) LCD and an FFS LCD.

Most of the liquid crystal displays are of an active matrix driving type, where each pixel is switched on/off by a thin-film transistor (TFT). The currently and commonly used thin-film transistors can be classified according to the material used in three categories: amorphous silicon (a-Si), indium gallium zinc oxide (IGZO), and low temperature polysilicon (LTPS). Amorphous silicon and indium gallium zinc oxide are affected by electron mobility and the thin-film transistor would be of a large size and the coupling capacitance C_{gs} is relatively large so that a practical operation thereof is subject to a feed-through voltage. Low temperature polysilicon has very high electron mobility and the size of a thin-film transistor device is relatively small and the influence of the feed-through voltage is also bettered. However, low temperature polysilicon has a relatively large leakage current. With the increase of pixel per inch, the size of the pixel is decreased and the liquid crystal capacitance C_{lc} of each pixel is also getting smaller. Under this condition, the feed-through voltage or the leakage current of a thin-film transistor device may have even severer influence on the image quality of a display device. To suppress the influence of the feed-through voltage or the leakage current of a thin-film transistor device, it is common to expand a storage capacitor Cₛₜ of each pixel. The inclusion of a storage capacitor Cₛₜ of a large capacitance helps reduce the feed-through voltage or the leakage current of the thin-film transistor device and lowers down the voltage of a pixel electrode so as to improve the image quality of a liquid crystal display.

Referring to FIGS. 1 and 2, FIG. 1 shows a conventional pixel structure used in a mobile phone screen and FIG. 2 is a cross-sectional view taken along line A-A of Figure. The pixel structure is of an FFS displaying mode so that the structure associated with the thin-film transistor is omitted in the drawings. Besides the structure associated with the thin-film transistor, the conventional pixel structure comprises at least the following portions: a data line 200, a pixel electrode 300, a common electrode 100, and a passivation (PV) layer 400 between the pixel electrode 300 and common electrode 100. The resolution of the mobile phones is getting increasingly high and the size of the pixels is getting increasingly small. Thus, the storage capacitance Cₛₜ between the pixel electrode 300 and common electrode 100 is getting increasingly small. On the other hand, the thin-film transistor is subjected to constraints of the manufacturing process and the material so that it is generally hard to reduce the feed-through voltage or the leakage current so that the displaying quality of the liquid crystal displays gets deteriorated.

Referring to FIG. 3, an effective solution that is currently adopted is to add a lower common electrode 504 under the pixel electrode 502. Since both upper and lower sides of the pixel electrode 502 are provided with a common electrode, there are two storage capacitors Cₛₜ existing in the pixel structure, respectively at the upper and lower sides of the pixel electrode 502 and being in an arrangement of parallel connection. Such a structure greatly increases the storage capacitance Cₛₜ of the pixel. The lower common electrode 504 that is located at the lower side of the pixel electrode 502 requires no strip like L/S structure so that the storage capacitance Cₛₜ provided thereby can be made even larger. However, heretofore, such a pixel structure suffers an issue of excessively large impedance of the lower common electrode 504.

Referring to FIGS. 4-6, the lower common electrode 504 needs to be connected a common electrode line in a peripheral circuit of a liquid crystal panel and each pixel has an external connection terminal. The material that makes the external connection terminal is the same as that making the common electrode. Further, the line width of the external connection terminal cannot be excessively large in order to induce an excessively large coupling capacitance with the data line 506, affecting the normal operation of the data line 506. These drawings also show a gate line 507. The upper common electrode 509, the common electrode, and the external connection terminal are all made of ITO (Indium Tin Oxides). Compared to metals, ITO has a very high resistance. Further, the external connection terminal is not allowed to have a large width, this causing an increase of the impedance of the external connection terminal. The increased impedance of the external connection terminal makes the voltage difference of the lower common electrode 504 in the entire panel increased, the distribution of potential being non-uniform, so as to affect the uniformity of the liquid crystal panel and deteriorate the reliability test of the liquid crystal panel.

### SUMMARY OF THE INVENTION

Thus, an object of the present invention is to provide a pixel structure, in which upper and lower common electrodes corresponding to a pixel electrode are connected in order to improve the uniformity of the potential of the lower common electrode by means of the excellent uniformity of the potential of the upper common electrode thereby improving the displaying quality and reliability of an FFS liquid crystal display using the pixel structure.

To achieve the object, the present invention provides a pixel structure, which comprises: a substrate, a lower common electrode and a gate line formed on the substrate, a first passivation layer formed on the lower common electrode and the substrate, a data line and a pixel electrode formed on the first passivation layer, a second passivation layer formed on the pixel electrode, the data line, and the first passivation layer, and an upper common electrode formed on the second passivation layer. The first passivation layer comprises a first via hole. The second passivation layer comprises a second via hole. The lower common electrode is connected through the first and second via holes to the upper common electrode. The lower common electrode and the pixel electrode partially overlap each other to form a first capacitor. The upper common electrode and the pixel electrode partially overlap each other to form a second capacitor. The first and second capacitors constitute a storage capacitor of the pixel structure.

The lower common electrode comprises a raised structure corresponding to the first and second via holes. The raised structure extends through the first and second via holes to connect to the upper common electrode. The raised structure further extends through a gate line of another pixel structure that is located under the pixel structure and is insulated from the gate line of said another pixel structure.

The raised structure is electrically connected through a connection layer to the lower common electrode. The connection layer, the lower common electrode, and the raised structure are formed simultaneously.

The raised structure comprises a circular pillar and the first and second via holes are both circular in shape.

The raised structure comprises a rectangular pillar and the first and second via holes are both rectangular in shape.

The upper common electrode comprises a portion overlapping the data line. The data line and the upper common electrode partially overlap each other to form a parasitic capacitor.

The lower common electrode comprises an ITO (Indium Tin Oxide) film pattern; the upper common electrode comprises an ITO film pattern; and the pixel electrode comprises an ITO film pattern.

The substrate is a transparent substrate and the substrate is a glass substrate or a plastic substrate.

The pixel structure further comprises two connection terminals extending from two opposite ends of the lower common electrode. The two connection terminals connect the lower common electrode to a common electrode line.

The two connection terminals are formed at the same time with the lower common electrode.

The present invention also provides a pixel structure, which comprises: a substrate, a lower common electrode and a gate line formed on the substrate, a first passivation layer formed on the lower common electrode and the substrate, a data line and a pixel electrode formed on the first passivation layer, a second passivation layer formed on the pixel electrode, the data line, and the first passivation layer, and an upper common electrode formed on the second passivation layer, the first passivation layer comprising a first via hole, the second passivation layer comprising a second via hole, the lower common electrode being connected through the first and second via holes to the upper common electrode, the lower common electrode and the pixel electrode partially overlapping each other to form a first capacitor, the upper common electrode and the pixel electrode partially overlapping each other to form a second capacitor, the first and second capacitors constituting a storage capacitor of the pixel structure;

wherein the lower common electrode comprises a raised structure corresponding to the first and second via holes, the raised structure extending through the first and second via holes to connect to the upper common electrode, the raised structure further extending through a gate line of another pixel structure that is located under the pixel structure and insulated from the gate line of said another pixel structure;

wherein the raised structure is electrically connected through a connection layer to the lower common electrode, the connection layer, the lower common electrode, and the raised structure being formed simultaneously;

wherein the raised structure comprises a circular pillar and the first and second via holes are both circular in shape; and

wherein the upper common electrode comprises a portion overlapping the data line, the data line and the upper common electrode partially overlapping each other to form a parasitic capacitor.

The lower common electrode comprises an ITO (Indium Tin Oxide) film pattern; the upper common electrode comprises an ITO film pattern; and the pixel electrode comprises an ITO film pattern.

The substrate is a transparent substrate and the substrate is a glass substrate or a plastic substrate.

The pixel structure further comprises two connection terminals extending from two opposite ends of the lower common electrode. The two connection terminals connect the lower common electrode to a common electrode line.

The two connection terminals are formed at the same time with the lower common electrode.

The efficacy of the present invention is that the present invention provides a pixel structure, in which upper and lower common electrodes that correspond to a pixel electrode are connected to each other through via holes to allow for improvement of the uniformity of the potential of the lower common electrode by means of the excellent uniformity of the potential of the upper common electrode and also to preserve a known arrangement of an external connection terminal so as to further improve the uniformity of the potential of the lower common electrode by means of the external connection terminal thereby improving the displaying quality and reliability of an FFS liquid crystal panel that uses the pixel structure.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic view showing a conventional pixel structure used in a mobile phone screen;

FIG. 2 is a cross-sectional view taken along line A-A of FIG. 1;

FIG. 3 is a schematic view showing a conventional pixel structure;

FIG. 4 is a schematic view showing a lower common electrode of the pixel structure shown in FIG. 3;

FIG. 5 is a schematic view showing a pixel electrode of the pixel structure shown in FIG. 3;

FIG. 6 is a schematic view showing an upper common electrode of the pixel structure shown in FIG. 3;

FIG. 7 is a schematic view showing a pixel structure according to the present invention;

FIG. 8 is a schematic view showing a lower common electrode of an embodiment of the pixel structure according to the present invention;

FIG. 9 is a schematic view showing a pixel electrode and an upper common electrode of an embodiment of the pixel structure according to the present invention;

FIG. 10 is a schematic view showing a lower common electrode of another embodiment of the pixel structure according to the present invention; and

FIG. 11 is a schematic view showing a pixel electrode and an upper common electrode of another embodiment of the pixel structure according to the present invention.

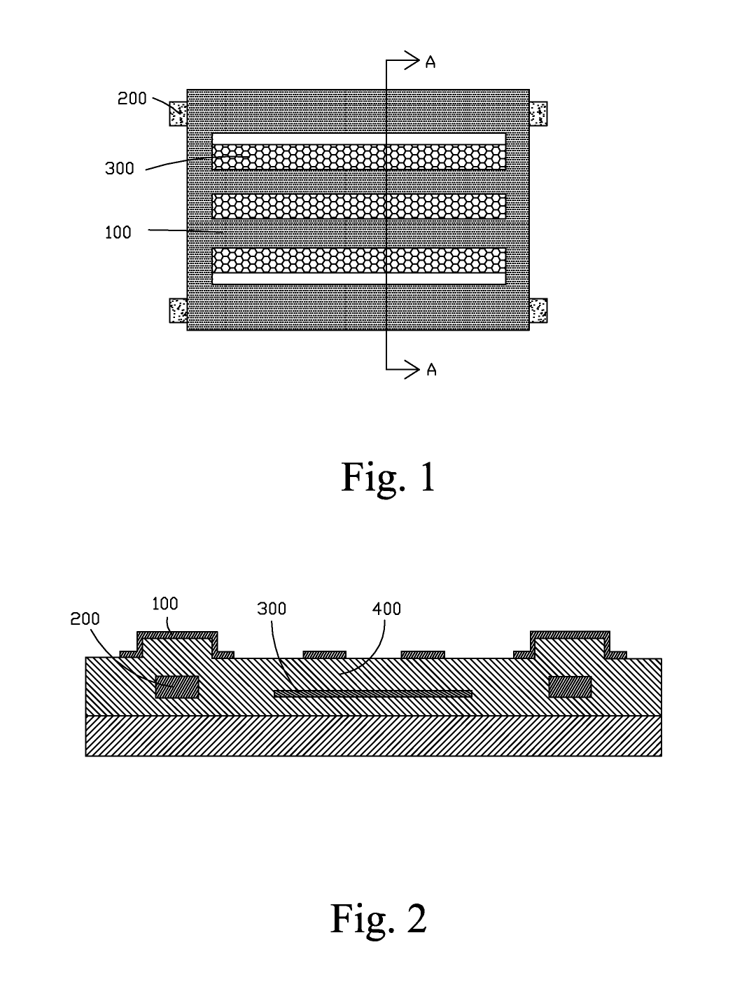

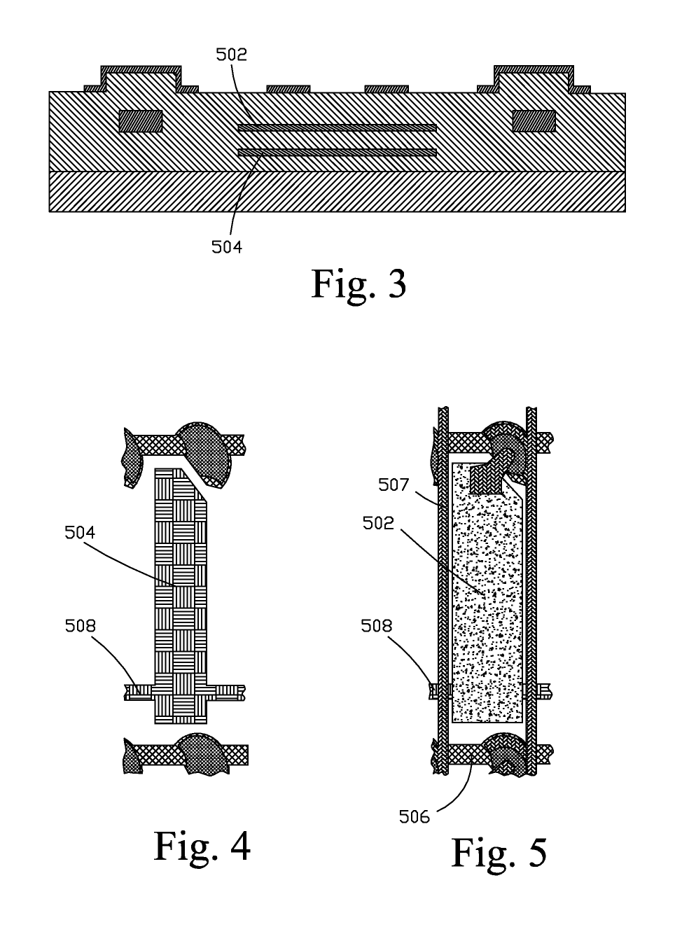

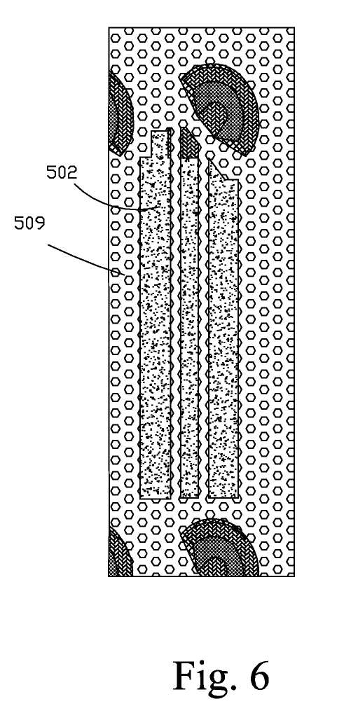

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

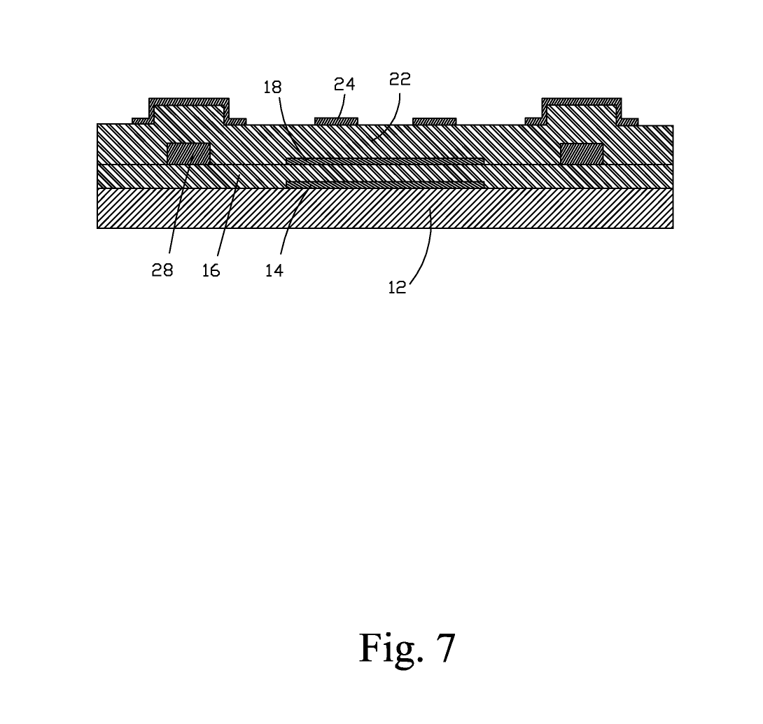

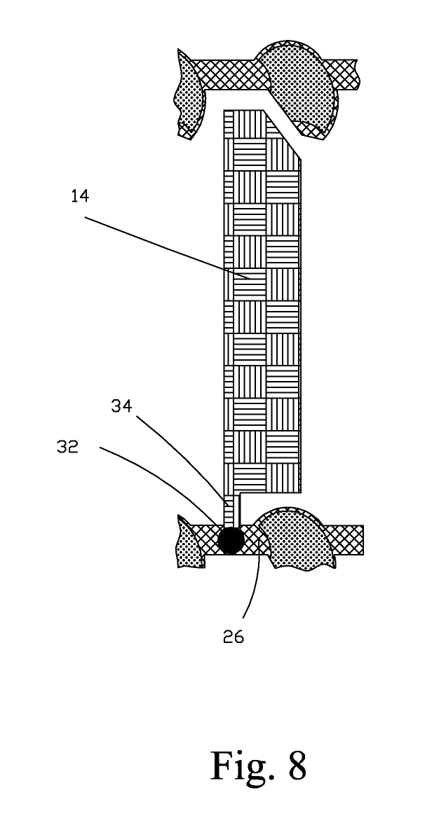

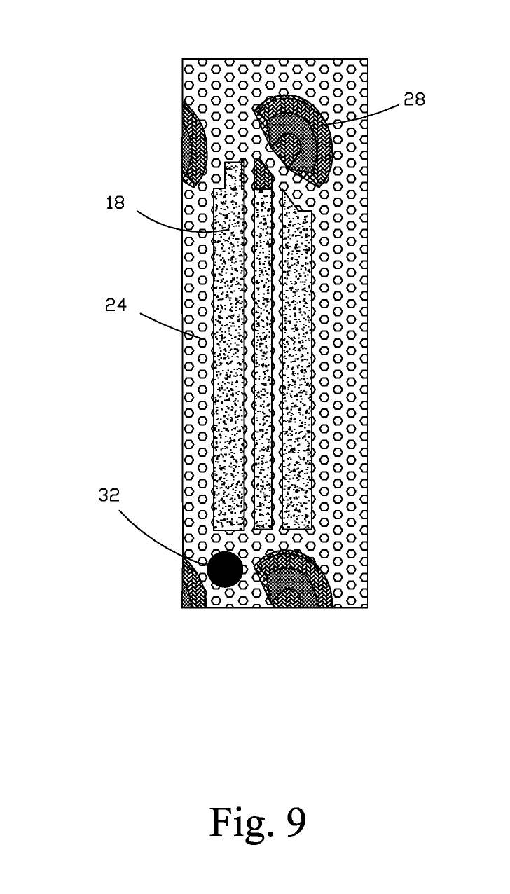

Referring to FIGS. 7-9, the present invention provides a pixel structure, which comprises: a substrate 12, a lower common electrode 14 and a gate line 26 formed on the substrate 12, a first passivation layer 16 formed on the lower common electrode 14 and the substrate 12, a data line 28 and a pixel electrode 18 formed on the first passivation layer 16, a second passivation layer 22 formed on the pixel electrode 18, the data line 28, and the first passivation layer 16, and an upper common electrode 24 formed on the second passivation layer 22. The first passivation layer 16 comprises a first via hole (not shown) and the second passivation layer 22 comprises a second via hole (not shown). The lower common electrode 14 is connected through the first and second via holes to the upper common electrode 24 so as to improve the uniformity of the potential of the lower common electrode 14 by means of the excellent uniformity of the potential of the upper common electrode 24. The lower common electrode 14 and the pixel electrode 18 partially overlap each other to form a first capacitor C₁. The upper common electrode 24 and the pixel electrode 18 partially overlap each other to form a second capacitor C₂. The first and second capacitors C₁, C₂ constitute a storage capacitor Cₛₜ of the pixel structure.

The present invention provides the arrangement of the upper and lower common electrodes 24, 14 to expand the storage capacitor Cₛₜ so as to improve the quality of a liquid crystal display. Further, the corresponding upper and lower common electrodes 24, 14 of the pixel electrode 18 are connected to each other so that the uniformity of the potential of the lower common electrode 14 can be improved by means of the excellent uniformly of the potential of the upper common electrode 24 thereby further improving the displaying quality and reliability of an FFS liquid crystal panel using the pixel structure. Specifically, the lower common electrode 14 comprises a raised structure 32 corresponding to the first and second via holes and the raised structure 32 extends through the first and second via holes to connect to the upper common electrode 24 so as to achieve the electrical connection between the upper and lower common electrodes 24, 14. Preferably, the raised structure 32 also extends through a gate line 26 of another pixel structure that is located under the pixel structure and is insulated from the gate line 26 of said another pixel structure. The raised structure 32 is electrically connected through a connection layer 34 to the lower common electrode 14. The connection layer 34, the lower common electrode 14, and the raised structure 32 can be formed simultaneously. The configuration of the raised structure 32 is determined according to practical needs and is preferably a circular pillar or a rectangular pillar and the first and second via holes are of corresponding shapes of circle or rectangle.

The upper common electrode 24 may have a structure similar to the prior art and may comprise a portion overlapping the data line 28. The overlapped portions of the data line 28 and the upper common electrode 24 form a parasitic capacitance C_{parasitic}. It is better if the parasitic capacitance C_{parasitic} is smaller in order to ensure the quality of signals through the data line 28.

The lower common electrode 14 comprises an ITO (Indium Tin Oxide) film pattern. The upper common electrode 24 comprises an ITO film pattern. The pixel electrode 18 comprises an ITO film pattern.

The substrate 12 is a transparent substrate. Further, the substrate 12 can be a glass substrate or a plastic substrate and is preferably a glass substrate in the instant embodiment.

The pixel structure further comprising a thin-film transistor formed on the transparent substrate 12 (where the thin-film transistor is not shown in the drawings for the purposes of easy observation of the drawings). The thin-film transistor comprises a gate terminal, a source terminal, and a drain terminal. The gate terminal is electrically connected to the gate line 26. The source terminal is electrically connected to the data line 28. The drain terminal is electrically connected to the pixel electrode 18. The drain terminal is electrically connected through a via hole to the pixel electrode 18.

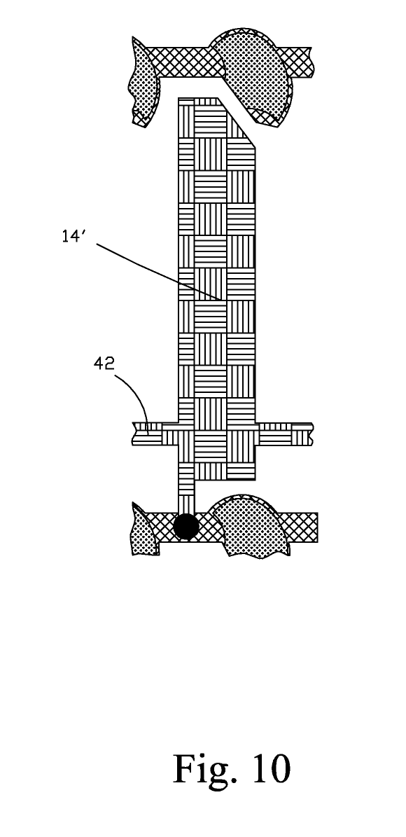

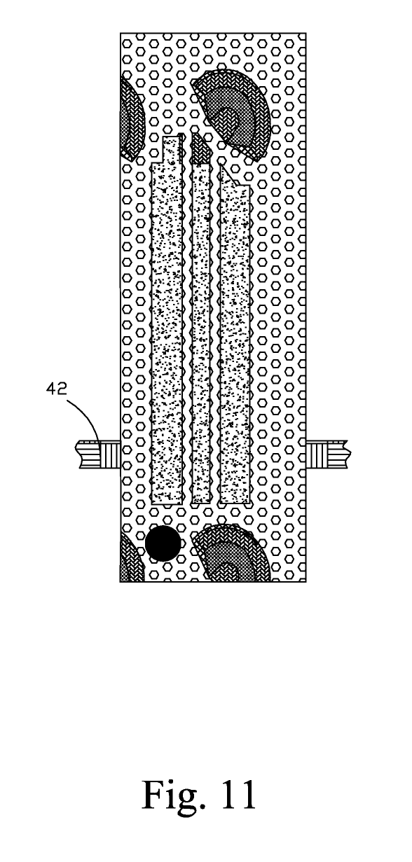

Referring to FIGS. 10 and 11, in another embodiment that can be alternatively used, the pixel structure may preserve and include a prior art arrangement in the described-above structure, namely comprising two connection terminals 42 that are formed by being extended outward from two ends of the lower common electrode 14′. The two connection terminals 42 connect the lower common electrode 14′ to a common electrode line (not shown). The connection terminals 42 may further improve the uniformity of the potential of the lower common electrode 14′ so as to improve the displaying quality and reliability of an FFS liquid crystal panel using the pixel structure.

The two connection terminals 42 can be formed at the same time with the lower common electrode 14′, the raised structure 32, and the connection layer 34 so as to ease the manufacturing thereof.

In summary, the present invention provides a pixel structure, in which upper and lower common electrodes that correspond to a pixel electrode are connected to each other through via holes to allow for improvement of the uniformity of the potential of the lower common electrode by means of the excellent uniformity of the potential of the upper common electrode and also to preserve a known arrangement of an external connection terminal so as to further improve the uniformity of the potential of the lower common electrode by means of the external connection terminal thereby improving the displaying quality and reliability of an FFS liquid crystal panel that uses the pixel structure.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A pixel structure, comprising: a substrate, a lower common electrode and a gate line formed on the substrate, a first passivation layer formed on the lower common electrode and the substrate, a data line and a pixel electrode formed on the first passivation layer, a second passivation layer formed on the pixel electrode, the data line, and the first passivation layer, and an upper common electrode formed on the second passivation layer, the first passivation layer comprising a first via hole, the second passivation layer comprising a second via hole, the lower common electrode being connected through the first and second via holes to the upper common electrode, the lower common electrode and the pixel electrode partially overlapping each other to form a first capacitor, the upper common electrode and the pixel electrode partially overlapping each other to form a second capacitor, the first and second capacitors constituting a storage capacitor of the pixel structure.

2. The pixel structure as claimed in claim 1, wherein the lower common electrode comprises a raised structure corresponding to the first and second via holes, the raised structure extending through the first and second via holes to connect to the upper common electrode, the raised structure further extending through a gate line of another pixel structure that is located under the pixel structure and insulated from the gate line of said another pixel structure.

3. The pixel structure as claimed in claim 2, wherein the raised structure is electrically connected through a connection layer to the lower common electrode, the connection layer, the lower common electrode, and the raised structure being formed simultaneously.

4. The pixel structure as claimed in claim 2, wherein the raised structure comprises a circular pillar and the first and second via holes are both circular in shape.

5. The pixel structure as claimed in claim 2, wherein the raised structure comprises a rectangular pillar and the first and second via holes are both rectangular in shape.

6. The pixel structure as claimed in claim 1, wherein the upper common electrode comprises a portion overlapping the data line, the data line and the upper common electrode partially overlapping each other to form a parasitic capacitor.

7. The pixel structure as claimed in claim 1, wherein the lower common electrode comprises an ITO (Indium Tin Oxide) film pattern; the upper common electrode comprises an ITO film pattern; and the pixel electrode comprises an ITO film pattern.

8. The pixel structure as claimed in claim 1, wherein the substrate is a transparent substrate and the substrate is a glass substrate or a plastic substrate.

9. The pixel structure as claimed in claim 1 further comprising two connection terminals extending from two opposite ends of the lower common electrode, the two connection terminals connecting the lower common electrode to a common electrode line.

10. The pixel structure as claimed in claim 9, wherein the two connection terminals are formed at the same time with the lower common electrode.

11. A pixel structure, comprising: a substrate, a lower common electrode and a gate line formed on the substrate, a first passivation layer formed on the lower common electrode and the substrate, a data line and a pixel electrode formed on the first passivation layer, a second passivation layer formed on the pixel electrode, the data line, and the first passivation layer, and an upper common electrode formed on the second passivation layer, the first passivation layer comprising a first via hole, the second passivation layer comprising a second via hole, the lower common electrode being connected through the first and second via holes to the upper common electrode, the lower common electrode and the pixel electrode partially overlapping each other to form a first capacitor, the upper common electrode and the pixel electrode partially overlapping each other to form a second capacitor, the first and second capacitors constituting a storage capacitor of the pixel structure;
wherein the lower common electrode comprises a raised structure corresponding to the first and second via holes, the raised structure extending through the first and second via holes to connect to the upper common electrode, the raised structure further extending through a gate line of another pixel structure that is located under the pixel structure and insulated from the gate line of said another pixel structure;
wherein the raised structure is electrically connected through a connection layer to the lower common electrode, the connection layer, the lower common electrode, and the raised structure being formed simultaneously;
wherein the raised structure comprises a circular pillar and the first and second via holes are both circular in shape; and
wherein the upper common electrode comprises a portion overlapping the data line, the data line and the upper common electrode partially overlapping each other to form a parasitic capacitor.

12. The pixel structure as claimed in claim 11, wherein the lower common electrode comprises an ITO (Indium Tin Oxide) film pattern; the upper common electrode comprises an ITO film pattern; and the pixel electrode comprises an ITO film pattern.

13. The pixel structure as claimed in claim 11, wherein the substrate is a transparent substrate and the substrate is a glass substrate or a plastic substrate.

14. The pixel structure as claimed in claim 11 further comprising two connection terminals extending from two opposite ends of the lower common electrode, the two connection terminals connecting the lower common electrode to a common electrode line.

15. The pixel structure as claimed in claim 14, wherein the two connection terminals are formed at the same time with the lower common electrode.
